(19) United States
(12) Patent Application Publication
(10) Pub. No.: US 2018/0120526 A1
(43) Pub. Date: May 3, 2018

(54) Optical Fiber Enclosure

(71) Applicant: Clearfield, Inc., Minneapolis, MN (US)

(72) Inventors: John P. Hill, Andover, MN (US); Todd Bade, Inver Grove Heights, MN (US)

(21) Appl. No.: 15/339,280

(22) Filed: Oct. 31, 2016

(51) Int. Cl. G02B 6/44; G02B 6/38

(52) U.S. Cl. CPC G02B 6/444; G02B 6/3897; G02B 6/4457

(57) ABSTRACT

An optical fiber enclosure comprises a housing, a spool, an adapter plate disposed in a space defined by an interior diameter of the spool, and a spacer coupling the adapter plate to the housing. The spacer is configured to separate the adapter plate from the spool to prevent rotation of the adapter plate with the spool.

### TECHNICAL FIELD

The present disclosure relates generally to optical fiber enclosures, and more specifically to optical fiber enclosures having an internal spool.

### BACKGROUND

Data, voice, and other communication networks are increasingly using fiber optics to carry information. In a fiber optic network, each individual fiber is generally connected to both a source and a destination device. Additionally, along the fiber optic run between the source and the destination, various connections or couplings may be made on the optical fiber to adjust the length of the fiber or to provide termination connection ports for end users at which one or more fibers may be branched from a feed cable.

To interconnect the cables, various cable connector designs provide for low insertion loss and stability. Some example connectors may include, but are not limited to, SC, Dual LC, LC, ST and MPO connectors. In most of these designs, ferrules (one in each connector, or one in the connector and one in the apparatus or device), each containing an optical fiber end, are butted together end to end and light travels across the junction.

With the increasing desire for completely optical networks, “fiber to the premises” (FTTP) or “fiber to the home” (FTTH) systems are being developed to provide optical fibers that extend from the source to the site of the end-user. Optical fiber enclosures are used for management of cables that extend to various user locations.

### SUMMARY

According to one aspect, there is disclosed an optical fiber enclosure comprising a housing, a spool configured to rotate to store optical fiber, an adapter plate disposed in a space defined by an interior diameter of the spool, and a spacer coupling the adapter plate to the housing. The spacer may be configured to separate the adapter plate from the spool to prevent rotation of the adapter plate with the spool.

The adapter plate may include a portion having a plurality of ports. In some embodiments, the adapter plate may be oriented such that the portion having the plurality of ports is tilted at an angle relative to an axis of rotation of the spool. In other embodiments, the adapter plate may be oriented such that the portion having the plurality of ports is substantially perpendicular to an axis of rotation of the spool. Each port of the plurality of ports may be configured to receive a respective optical fiber connector. The housing may further comprise a plurality of port openings configured to align with the plurality of ports.

In some embodiments, the adapter plate may be pre-connectorized. In some embodiments, the spool may be configured to store about 200 feet of optical fiber cable. In some embodiments, the enclosure may further comprise a strap coupled to the housing and configured to engage an opening of the spool to prevent rotation of the spool.

In some embodiments, the housing may include a hinged cover. In some embodiments, the enclosure may comprise a gasket seal.

The present disclosure is not limited in terms of the particular embodiments described in this application, which are intended as illustrations of various aspects. Many modifications and variations can be made without departing from its spirit and scope, as will be apparent to those skilled in the art.

### BRIEF DESCRIPTION OF THE FIGURES

FIG. 1 is a perspective view of one embodiment of an enclosure configured according to aspects of the present disclosure;

FIG. 2 is a perspective view of the enclosure of FIG. 1, showing the spool assembly according to aspects of the present disclosure;

FIG. 3 is a perspective view further showing the adapter plate and spool configured according to aspects of the present disclosure;

FIG. 4 is a perspective view further showing a plurality of connectors coupled to the adapter plate according to aspects of the present disclosure; and

FIG. 5 is a top view of the inside of the enclosure of FIG. 1 configured according to aspects of the present disclosure.

### DETAILED DESCRIPTION

Aspects of the present disclosure are directed at optical fiber enclosures that provide slack fiber storage. Embodiments of the optical fiber enclosures may be configured for use as a wall box at various user locations, for example, at multi-dwelling units, single family units, cellular towers and business class services.

Embodiments of the optical fiber enclosure may be configured to accept a variety of drop cables, which allows the enclosure to be integrated into any network architecture and deployment.

Various embodiments of optical fiber enclosures disclosed herein simplify fiber deployment. For example, the distance to a user location may be unknown. Embodiments of optical fiber enclosures may include a spool configured to allow optical fiber cable to be pulled out of the enclosure to a desired length, and any slack storage may be held in the spool. Thus, various embodiments eliminate the need for exact fiber cable lengths, and protect excess fiber by storing it on the spool. Various embodiments of the optical fiber enclosures may have a built-in feature that locks the spool in place once the optical fiber has been pulled to the specified location.

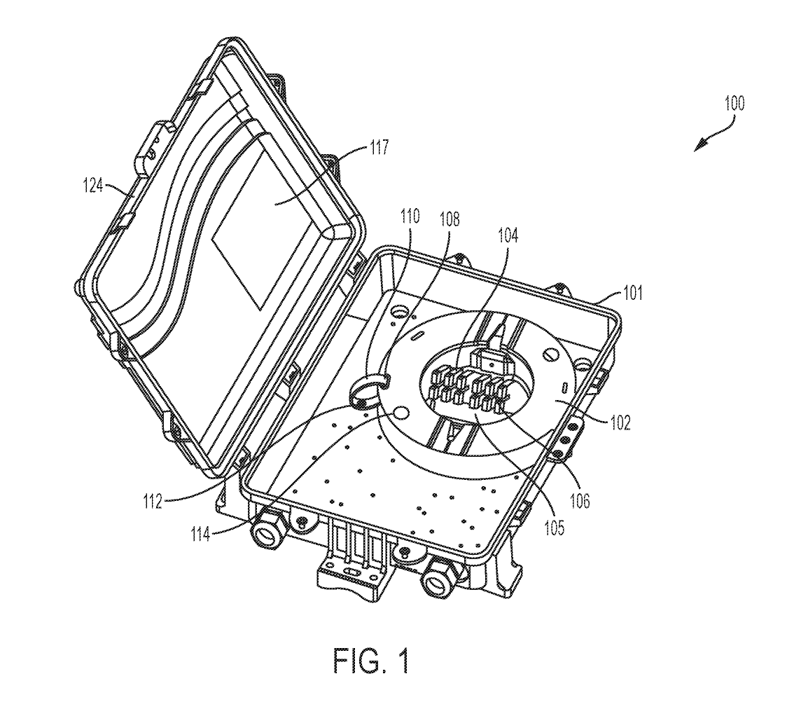

FIG. 1 shows one embodiment of an enclosure 100. The enclosure 100 includes a housing 101. In this embodiment, the housing 101 is a rectangular wall box. In other embodiments, the housing may have a different shape. The enclosure 100 includes a spool 102 and an adapter plate 104. The spool 102 is an internal spool placed inside the housing 101 of the enclosure 100.

The spool 102 is configured to rotate so as to store excess optical fiber cable inside the enclosure 100. The spool 102 holds up to 200 feet of 3 mm, 12 fiber micro cable. The spool may also hold, for example, 125 feet of 4 mm, 24 fiber micro cable, or 100 feet of 5.5 mm OSP cable. This is the most fiber held in a spool in the industry. In various embodiments, the spool may be the sole cable management structure. In various embodiments, the spool may be configured so as not to have any removable parts, or any tear-away sections.

The spool 102 includes an opening 108 configured to receive a strap 110. The strap 110 is configured to lock the spool 102 in place to prevent rotation of the spool. The strap 110 is attached to the housing 101 of the enclosure 100 using a screw 112. In other embodiments, the strap may be attached by another mechanism. The spool 102 also includes finger holes 114 for winding back excess fiber to the spool. In other embodiments, the enclosure may not include a strap, and the spool may not include either an opening for the strap or finger holes for winding back excess cable.

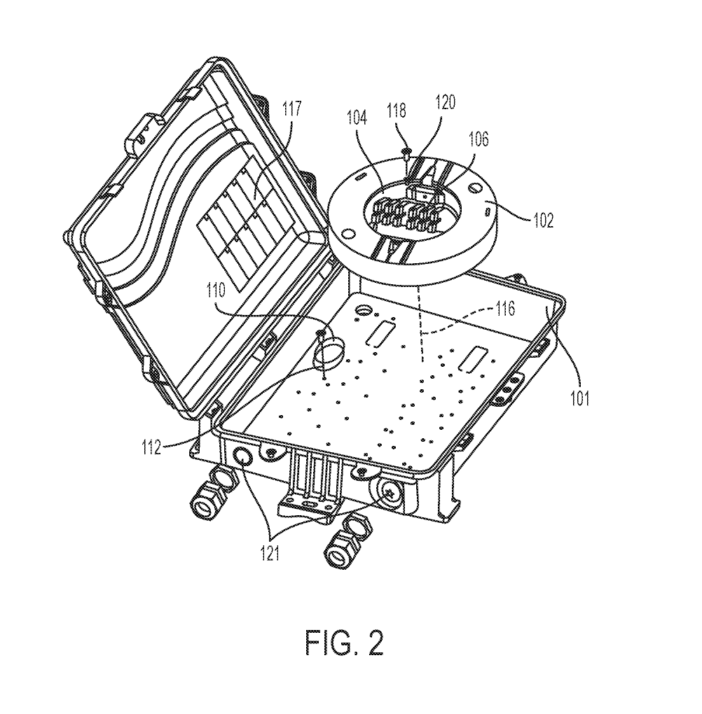

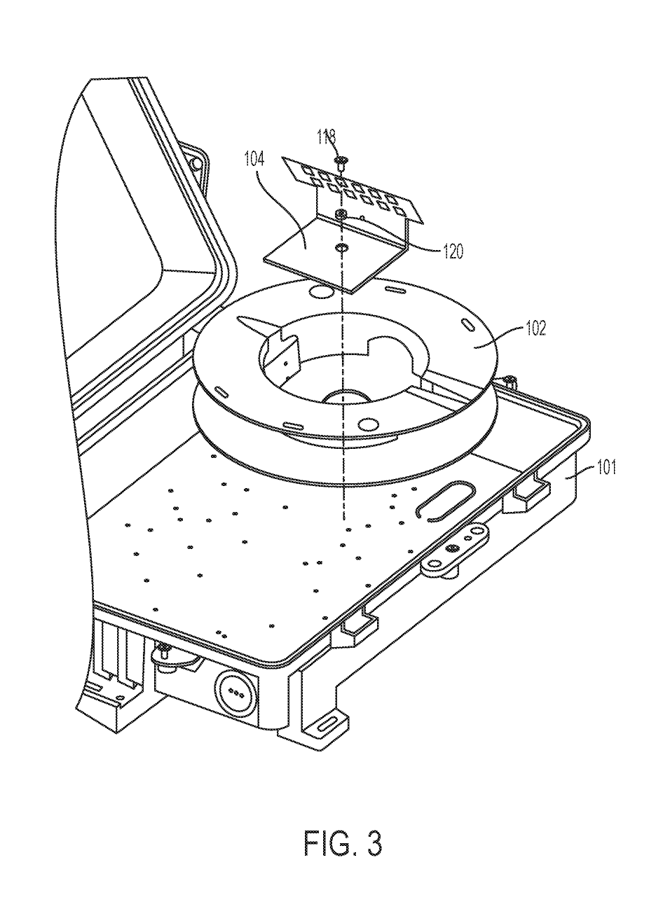

The spool 102 has an inside diameter sized to accommodate the adapter plate 104. The adapter plate 104 fits inside the spool 102. Specifically, the adapter plate 104 is disposed in a space 105 defined by an interior diameter of the spool 102. The adapter plate 104 includes a portion having a plurality of ports 106. For example, the adapter plate 104 may have a plurality of ports configured to receive either 12 SC connectors or 24 LC connectors. In some embodiments, as shown for example in FIGS. 2 and 3, the adapter plate 104 may be positioned such that at least a portion of the adapter plate including the adapter ports is tilted at an angle relative to the axis of rotation 116 of the spool 102. In other embodiments, the adapter plate 104 may be positioned such that the a portion of the adapter plate having the adapter ports is substantially perpendicular to the axis of rotation 116. In various embodiments, the adapter plate need not pivot. The housing 101 of the enclosure 100 may further include one or more port openings 117. As shown in FIG. 2, the port openings 117 are configured to align with the adapter ports 106 of the adapter plate 104. As shown in FIG. 2, the housing 101 of the enclosure 100 further includes two bottom ¾ inch entry/exit ports 121.

As shown in FIG. 3, the adapter plate 104 is held in place with a screw 118 and a spacer 120 separating it from the spool 102. The screw 118 and spacer 120 may be used to spin the spool 102. The spool 102 and the adapter plate 104 are configured such that the spool rotates independently of the adapter plate. The spool 102 and the adapter plate 104 are not attached. The spacer 120 allows the spool 102 to rotate independently of the adapter plate 104. In various embodiments, the adapter plate 104 is stationary, and therefore does not move or pivot as the spool rotates.

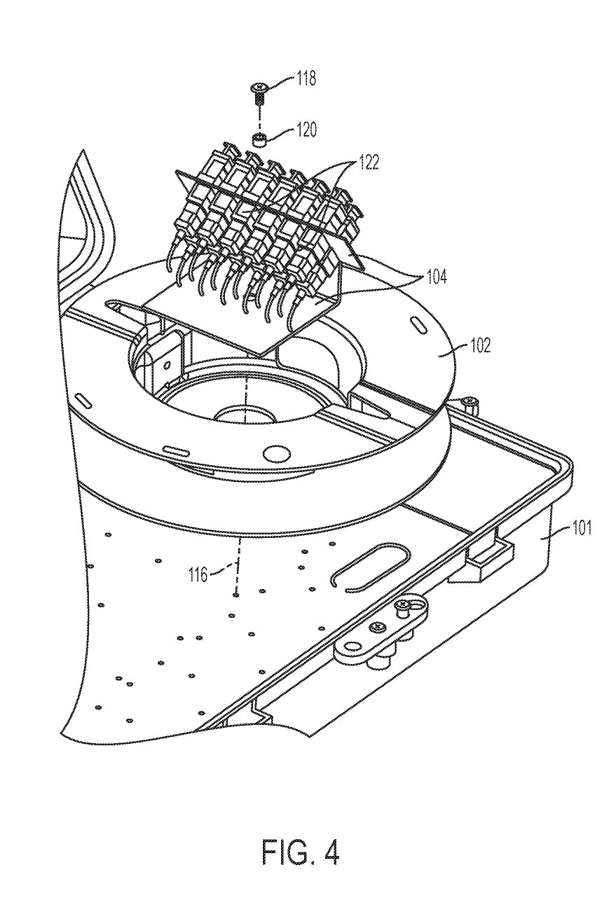

FIG. 4 shows a plurality of connectors 122 coupled to the adapter plate 104. The portion of the adapter plate 104 having the connectors is tilted relative to the axis of rotation 116 of the spool 102.

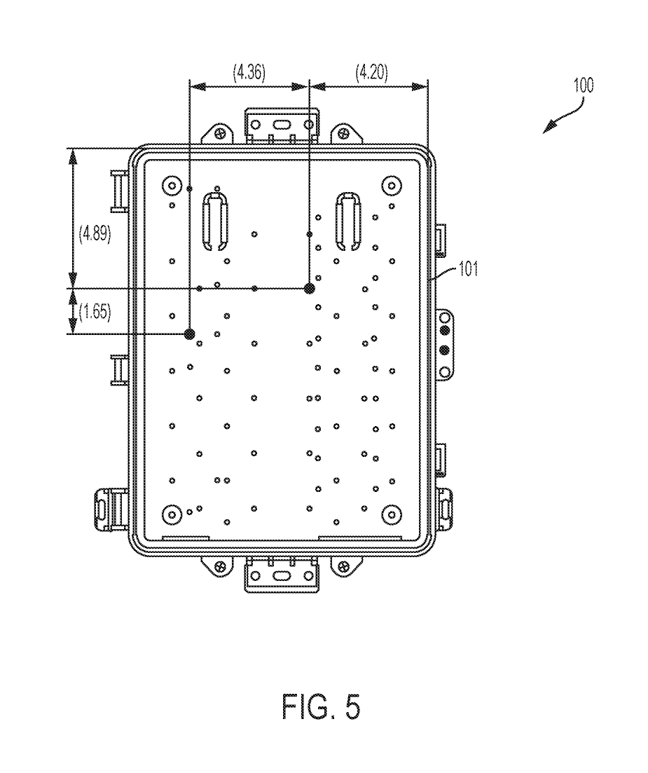

FIG. 5 is a top view of the inside of the enclosure 100, showing one example of dimensions. In one example, the inside of the enclosure has a height of about 14.1 inches, a width of about 10 inches and a depth of about 5.25 inches. Other embodiments may have different dimensions. In some embodiments, the spool may be manufactured by blow molding.

In some embodiments, the enclosure may provide 12 SC or 24 LC connections on the front of the spool and MPO, plug-and-play, SC/LC breakouts or pigtails on the back side of the spool. Various embodiments of the enclosure may provide fiber terminations that are Telcordia GR-326 compliant. Various embodiments may support all industry standard single mode and multi-mode connectors. Various embodiments of the enclosure have less than or equal to about 0.2 dB insertion loss, exceeding industry standards.

Various embodiments may be configured for both indoor and outdoor use. Embodiments of the optical fiber enclosure may have a housing 101 a having hinged removable cover 124, as shown for example in FIG. 1, making it is easy for craft personnel to access the enclosure during both initial service installation and ongoing maintenance. Various embodiments of the enclosure may include a gasket seal for protection from elements. In various embodiments, the enclosure may have one or more sealed or sealable ports for protection from elements or operation in an outdoor environment. Some embodiments may be made of high-impact and flame retardant PVC for durability.

Various embodiments of the optical fiber enclosure may be configured for wall mounting. In some embodiments, the enclosure may include a security screw with the ability to secure with padlock.

Various embodiments of the optical fiber enclosures disclosed herein are designed to fast-track and simplify fiber installations when landing, for example, 12 to 24 fibers in any environment. Some embodiments disclosed herein may include a pre-connectorized adapter plate, eliminating labor and speeding network construction. Various embodiments have a compact design that efficiently uses available space. The compact design can be pre-configured to terminate, for example, up to 24 fibers. Various embodiments disclosed herein are simpler and easier to use than conventional enclosures. Instead of ball bearings or special molded spindles, a simple screw and spacer may be used to spin the spool.

Various embodiments of the optical fiber enclosure may be configured to accept a variety of drop cables. Various embodiments of the enclosure may be integrated into any network architecture and deployment. For example, the enclosure may be used in a fiber distribution system comprising one or more distribution terminals. In some embodiments, the fiber distribution system may comprise a plurality of distribution terminals arranged in a daisy chained configuration. A distribution terminal may have at least one feeder port and a plurality of distribution ports. Each of the at least one feeder port and the plurality of distribution ports may be sealable ports configured to receive a duct configured to receive pushable fiber therethrough or a connector, and the connector may be configured to interface with a drop type cable. The fiber distribution system may comprise an enclosure configured according to aspects of the present disclosure. The enclosure may be configured as a tap box for mounting at a user location. The enclosure may have at least one sealable port configured to receive one of a connector and a duct configured to receive pushable fiber therethrough, and may include a spool and adapter plate as disclosed. In some embodiments, the sealable ports of the enclosure may further include anti-rotation locking features.

In some embodiments, the distribution terminal may be configured to receive a fiber through the feeder port and to output a plurality of fibers through the plurality of distribution ports of the terminal, at least one fiber of the plurality of fibers being received by the enclosure through the sealable port of the enclosure.

In some embodiments, the terminal may be configured to receive a plurality of swappable modules. In some embodiments, the module may be configured to receive different types of splitters having different split ratios. In some embodiments, the module may be configured to receive any optical component, including any type of connector.

In some embodiments, the enclosure may comprise a single spool. In other embodiments, the enclosure may comprise a plurality of spools. The plurality of spools may be stackable and configured to provide slack storage, for example, of about 600 feet. The plurality of spools may be configured to rotate independently of the adapter plate. In some embodiments, the enclosure and adapter plate of the enclosure may be configured to receive any type of connector. In some embodiments, the enclosure may be configured to receive a plurality of different types of drop cables.

The fiber distribution system may further comprise a plurality of connectors. The connectors may be configured to couple with a plurality of distribution ports of the distribution terminal. The adapter plate of the enclosure may be configured to receive the connectors. In some embodiments, each connector of the plurality of connectors may be configured to receive epoxy so as to provide a hardened connector.

In some embodiments, the enclosure may comprise a mount configured to attach the enclosure to a user location. The enclosure may comprise at least one sealable port configured to receive one of a connector and a duct configured to receive pushable fiber therethrough. The enclosure may comprise at least one port configured to provide a drop cable to the user location, and at least one spool. In some embodiments, the enclosure may be configured to provide a plurality of different types of drop cables.

This disclosure is not limited to the particular systems, devices and methods described, as these may vary. The terminology used in the description is for the purpose of describing the particular versions or embodiments only, and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. An optical fiber enclosure, comprising:
a housing;
a spool configured to rotate to store optical fiber;
an adapter plate disposed in a space defined by an interior diameter of the spool; and
a spacer coupling the adapter plate to the housing, the spacer being configured to separate the adapter plate from the spool to prevent rotation of the adapter plate with the spool.

2. The optical fiber enclosure of claim 1, wherein the adapter plate includes a portion having a plurality of ports.

3. The optical fiber enclosure of claim 2, wherein the adapter plate is oriented such that the portion having the plurality of ports is tilted at an angle relative to an axis of rotation of the spool.

4. The optical fiber enclosure of claim 2, wherein the adapter plate is oriented such that the portion having the plurality of ports is substantially perpendicular to an axis of rotation of the spool.

5. The optical fiber enclosure of claim 2, wherein each port of the plurality of ports is configured to receive a respective optical fiber connector.

6. The optical fiber enclosure of claim 2, wherein the housing comprises a plurality of port openings configured to align with the plurality of ports.

7. The optical fiber enclosure of claim 1, further comprising a strap coupled to the housing and configured to engage an opening of the spool to prevent rotation of the spool.

8. The optical fiber enclosure of claim 1, wherein the housing includes a hinged cover.

9. The optical fiber enclosure of claim 1, wherein the spool is further configured to store about 200 feet of optical fiber cable.

10. The optical fiber enclosure of claim 1, further comprising a gasket seal.

11. The optical fiber enclosure of claim 1, wherein the adapter plate is pre-connectorized.
